(19) United States
(12) Patent Application Publication
(10) Pub. No.: US 2026/0133746 A1
(43) Pub. Date: May 14, 2026

(54) CONTENT SHARING USER INTERFACES

(71) Applicant: Hewlett-Packard Development Company, L.P., Spring, TX (US)

(72) Inventors: Andre da Fonte Lopes da Silva, Palo Alto, CA (US); Chan Woo Park, Spring, TX (US)

(73) Assignee: Hewlett-Packard Development Company, L.P., Spring, TX (US)

(21) Appl. No.: 19/118,149

(22) PCT Filed: Oct. 11, 2022
(86) PCT No.: PCT/US2022/046225

§ 371 Date: Apr. 3, 2025

(51) Int. Cl. G06F 3/14; H04L 65/4038

(52) U.S. Cl. CPC G06F 3/1462; H04L 65/4038

(57) ABSTRACT

The present disclosure describes a device that includes a processor resource, and a non-transitory memory resource storing machine-readable instructions stored thereon that, when executed, cause the processor resource to: designate a first portion of a user interface to share content with a remote device through a conferencing application and designate a second portion of the user interface to display the content from the conferencing application to represent the content as it is received by the remote device.

### BACKGROUND

A computing device can be utilized to communicate with remote computing devices over a network. The computing device can utilize a user interface to allow a user to provide inputs and interact with the computing device to perform particular functions. Computing devices can be utilized to allow remote users to communicate and/or share information over a network utilizing the user interface.

### BRIEF DESCRIPTION OF THE DRAWINGS

FIG. 1 illustrates an example of a method for content sharing user interfaces.

FIG. 2 illustrates an example of a system for content sharing user interfaces.

FIG. 3 illustrates an example of a device for content sharing user interfaces.

FIG. 4 illustrates an example of a memory resource storing instructions for content sharing user interfaces.

FIG. 5 illustrates an example of a system for content sharing user interfaces.

### DETAILED DESCRIPTION

A user may utilize a computing device for various purposes, such as for business and/or recreational use. As used herein, the term “computing device” refers to an electronic system having a processor (e.g., processor resource, hardware processor, etc.) and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are, or can be, carried and/or worn by a user.

A computing device can be utilized to execute a conferencing application that can allow a plurality of computing devices to share audio data and/or image data (e.g., images, video, text, etc.). As used herein, a conferencing application can include instructions to provide a conference between a plurality of computing devices such that the plurality of computing devices attending the conference can share information (e.g., content, image data, audio data, etc.). In this way, a plurality of users can communicate with remote users through a plurality of computing devices utilizing a conferencing application. In some examples, the conferencing application can include a user interface that is displayed on a display device of a computing device. For example, a computing device can execute the conferencing application to connect with a plurality of remote computing devices. In this example, the computing device can include a display device to display a user interface associated with the conferencing application. As used herein, a user interface includes instructions to receive inputs and/or provides outputs to allow a user to interact with the computing device.

The user interface can include instructions to allow a user of the computing device to interact with the conferencing application. For example, the user can make selections within the user interface of the conferencing application to instruct the conferencing application to perform particular functions. For example, the user interface can include selections for admitting users to join a particular conference, remove users from a particular conference, mute particular users, share video from a camera, share images, share images displayed on a display device, among other selections that can instruct the conferencing application to perform functions. In a specific example, the conferencing application can be instructed through the user interface to perform a screen sharing function. As used herein, a screen sharing function includes instructions for sharing image data that is currently displayed on a display device with the conferencing application. In these examples, the conferencing application receives the image data that is being displayed on the display device and transmits (e.g., instructs a network interface device to transmit) the image data to other computing devices that are attending a particular conference. In this way, a particular user of a conference can share images and/or videos with a plurality of other users that are attending the conference associated with the conferencing application.

In some examples, the images displayed on a first display device of a first user sharing the image data can appear differently on a second display device of a second user receiving the image data. For example, a delay can occur between what is currently displayed on the first display and what is displayed on the second display. The delay can result in a miscommunication between the first user and the second user when discussing the image data. In other examples, the image data quality can appear differently on the first display and the second display. In these examples, the network connection metrics and/or computing device metrics may not be capable of transmitting the image data without degrading the image quality. In this way, the images displayed on the second display device may not appear like the images displayed on the second display device.

The present disclosure describes systems and devices for content sharing user interfaces. The content sharing user interfaces can be utilized with a conferencing application and/or a user interface associated with the conferencing application. The content sharing user interfaces can designate a first portion of the user interface as a sharing portion and a second portion of the user interface as a receiving portion. Image data within the first portion of the user interface can be shared with conferencing application to be provided to other users within a particular conference. The image data within the second portion is the image data received by the conferencing application of the image data within the first portion. In this way, the user interface can display the content to be shared and display the content as it is received by remote computing devices.

The user interface can be utilized to simultaneously display the image data that is being shared and how the shared image data is being received. This can allow a user to ensure that the end user is viewing the same image data as what is currently displayed withing the first portion. In addition, the user interface can allow the user to ensure that the image quality that an end user is receiving is similar or the same as the image quality of the image data being shared within the first portion. Furthermore, the user interface can display network connection metrics and/or computing device metrics to ensure the user sharing the image data maintains a threshold level for sharing particular image data. In addition, the user interface can generate notifications when the image data received by the end user or displayed in the second portion is below a threshold, when the network connection metrics are below a particular threshold, and/or when the computing device metrics are below a particular threshold.

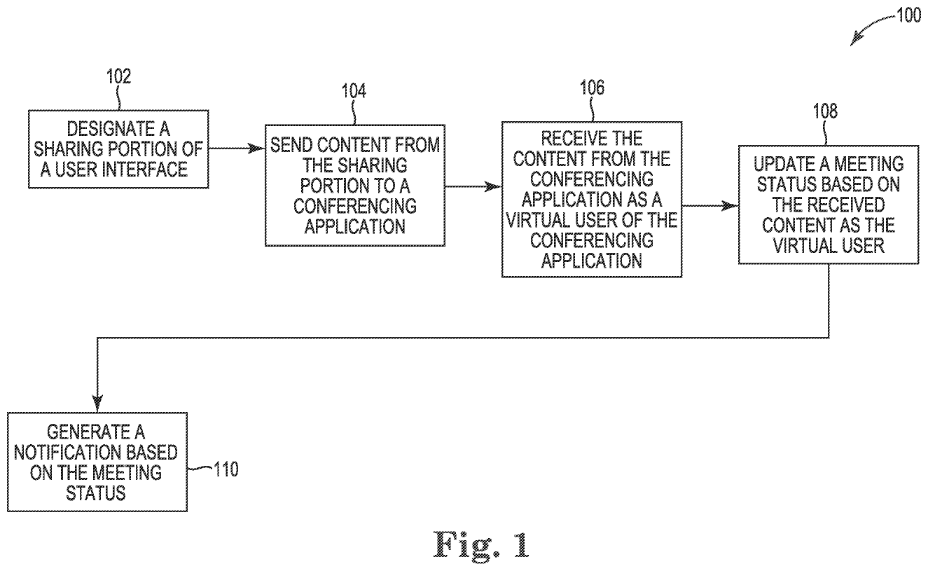

FIG. 1 illustrates an example of a method 100 for content sharing user interfaces. In some examples, the method 100 can be executed by a computing device and/or a computing system that includes a plurality of computing devices. In some examples, the method 100 can be utilized to display device metrics (e.g., network metrics associated with a device, processor metrics, memory metrics, etc.) along with image data received from a conferencing application to allow a user to monitor how a remote participant is receiving image data. In this way, a user sharing the image data does not have to ask a participant of the conference what the participant is seeing or if there are image quality issues associated with the participant's computing device.

In some examples, at 102, the method 100 can include designating a sharing portion of a user interface. In these examples, the sharing portion of the user interface is a designated portion of the user interface that is to be shared with or transferred to a conferencing application. In this way, the sharing portion is a portion of the user interface that is being shared or provided to other users that are participants of a particular conference. In this way, a plurality of users can be associated with a conference through the conferencing application. The conferencing application can receive inputs from the plurality of participants and distribute the inputs to the other participants of the conference.

The sharing portion can be a designated area of the user interface that can include image data that is being displayed by a display device. In this way, the user of the display device can position image data that is to be shared or provided to the participants of the conference within the sharing portion of the user interface. In this way, the image data that is positioned within the sharing portion can be transmitted to the conferencing application and provided to the plurality of participant computing devices that are connected to the conferencing application. In some examples, image data outside the sharing portion is not provided to the conferencing application and/or restricted from being provided to the conferencing application.

In some examples, at 104, the method 100 can include sending content from the sharing portion to a conferencing application. In some examples, the conferencing application can include instructions to receive the content (e.g., image data, sound data, etc.) within the sharing portion of the user interface and transmitting the content to a plurality of remote computing devices through a network. As described herein, the conferencing application can be utilized to organize data transmissions between a plurality of computing devices that are attending a particular conference. In this way, users associated with the plurality of computing devices can share information with the other users attending the conference.

In some examples, at 106, the method 100 can include receiving the content from the conferencing application as a virtual user of the conferencing application. As described further herein, a user utilizing the content sharing user interface to share content through the sharing portion can utilize a virtual user to display the content being provided to the conferencing application by the user. As used herein, a virtual user can be a computing bot or other set of instructions that acts like a remote attending user and receives content from the conferencing application as if it were a real attending user. In these examples, the content received by the virtual user of the conferencing application can be displayed on a virtual user portion of the user interface. In some examples, the virtual user portion can be displayed by the display device simultaneously with the content within the sharing portion. In this way, the display device can display what a user is intending to share within the sharing portion and what a remote participant of the conferencing application is viewing within the virtual user portion.

In some examples, at 108, the method 100 can include updating a meeting status based on the received content as the virtual user. In some examples, the meeting status can include meeting metrics for the conference provided by the conferencing application. In these examples, the meeting metrics can include, but are not limited to: network metrics, processing metrics, memory metrics, refresh rate, image quality, among other computing metrics that can affect the quality or experience of the attendees of the conference.

In some examples, at 110, the method 100 can include generating a notification based on the meeting status. In some examples, the notifications can indicate that a remote computing device is displaying the content being shared within the sharing portion of the user interface. For example, the notification can be an indicator that the remote computing devices that are connected to the conferencing applications are able to view the content being shared. In some examples, the notifications can include a recommendation for altering a computing device or network connection to increase the computing metrics.

In some examples, the notifications can be generated based on threshold metric values. For example, the notifications can be generated when a network connection speed falls below a network connection speed threshold value. In this way, the notification can indicate that the network connection speed is not capable of providing the content to the plurality of remote computing devices attending the conference. In this example, the notification can include recommendations for increasing the network connection speed above the network connection speed threshold value. In this way, the notification can notify the user that the participants of the conference may not be viewing the content in the same way as the sharing user is viewing the content within the sharing window. In addition, the notification can provide a recommendation for providing higher quality content to the participants.

In some examples, the threshold metric values can be altered based on the content being shared. For example, a first set of threshold metric values can be utilized when still images are being shared within the sharing portion and a second set of threshold metric values can be utilized when video images are being shared within the sharing portion. In this way, content that may utilize more computing and/or networking resources can utilize higher threshold metric values compared to content that may utilize less computing and/or networking resources.

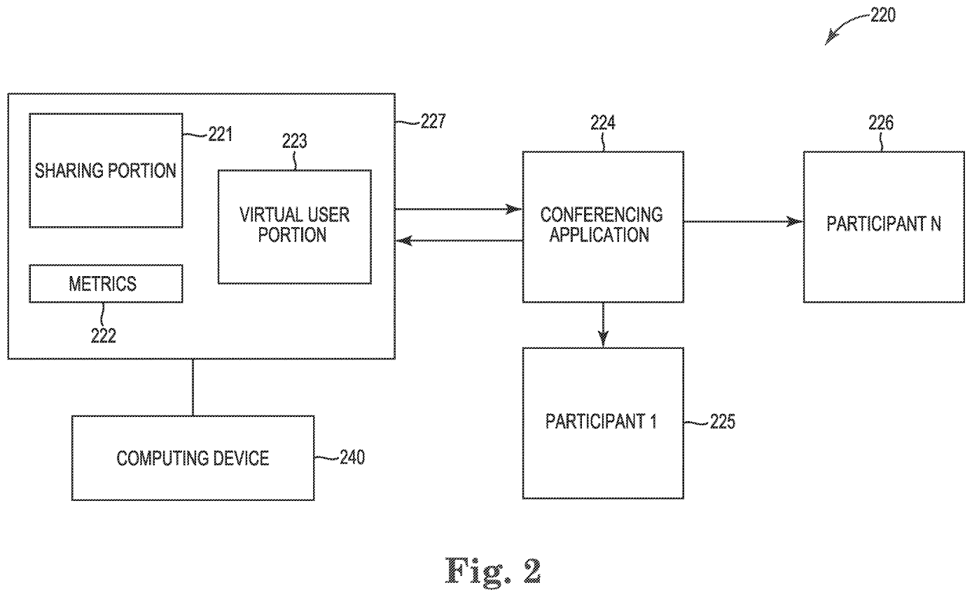

FIG. 2 illustrates an example of a system 220 for content sharing user interfaces. In some examples, the system 220 can illustrate a network of computing devices and/or a computing system that is performing a conference utilizing a conferencing application 224. In some examples, the conferencing application 224 can be stored on a computing device 240 and/or on one or more participant devices 225, 226. Although two participant devices 225, 226 are illustrated in FIG. 2, a greater number or fewer number of participant devices can be utilized. As used herein, a participant device can be a device that is attending a conference of the conferencing application 224.

In some examples, the computing device 240 can be utilized to generate a user interface 227 that can be displayed on a display device. The user interface 227 can include a sharing portion 221, a virtual user portion 223, and a metrics portion 222, As described herein, the sharing portion 221 can be a designated area within the user interface 227 that is provided to the conferencing application 224 to be provided to the participant devices 225, 226. As described herein, a user of the computing device 240 can select content or image data to be positioned within the sharing portion 221 and/or select content or image data to be positioned outside the sharing portion 221. In this way, the content to be provided to the conferencing application 224 and/or participant devices 225, 226.

In some examples, the content provided to the conferencing application 224 can be provided to the computing device 240 and/or user interface 227 to be provided to a virtual user and displayed within the virtual user portion 223. In this way, the content within the sharing portion 221 can be provided to the virtual user as if the virtual user was one of the participant devices 225, 226. The displayed content within the virtual user portion 223 can be an indication of what is being displayed by the participant devices 225, 226. In some examples, a delay or lag can occur when sharing content through the sharing portion 221. In these examples, the virtual user portion 223 can be utilized to monitor the delay or lag such that a user utilizing the user interface 227 can wait for the delay or lag to pass before proceeding with a discussion of the content within the sharing portion.

In some examples, the virtual user portion 223 can be utilized to monitor an image quality of the content provided to the conferencing application 224 within the sharing portion 221. For example, the image quality of the virtual user portion 223 can be compared to the image quality within the sharing portion 221 to determine when an image quality difference is greater than a threshold. In these examples, a notification can be generated and displayed within the user interface 227 to indicate that the image quality difference is greater than the threshold. As described herein, the notification can include a recommendation for increasing the image quality of the content within the virtual user portion 223.

In some examples, the user interface 227 includes a metrics portion 222. The metrics portion 222 can include current metrics of the computing device 240, conferencing application, and/or network connection of the computing device 240. As described herein, the metrics portion 222 can display the current computing metrics associated with the conference between the computing device 240 and the participant devices 225, 226. In some examples, the plurality of metrics displayed within the metrics portion 222 can each include a corresponding metric threshold. As described herein, the metric threshold can be a threshold resource level for providing the content within the sharing portion 221 to the conferencing application 224 such that the content is received by the participants 225, 226. As described herein, the metric thresholds can be based on the type of content positioned within the sharing portion 221. For example, a greater threshold level can be utilized when sharing video image content and a lower threshold level can be utilized when sharing still image content.

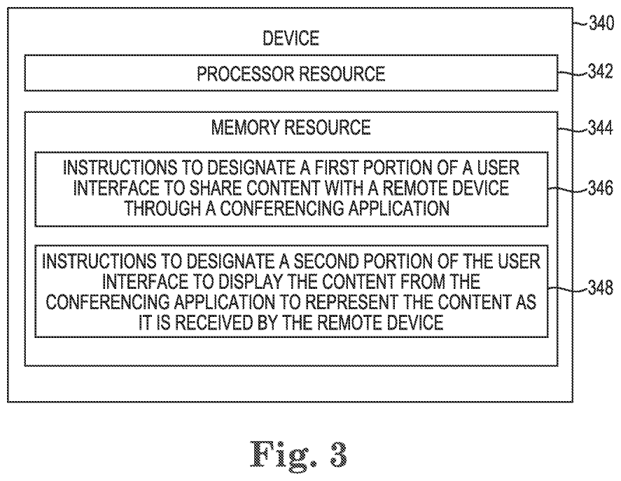

FIG. 3 illustrates an example of a device 340 for content sharing user interfaces. The device 340 can be a computing device that can include a processor 342 that can execute instructions 346, 348 to perform the methods described herein. In some examples, the device 340 can a computing device that is communicatively coupled to a remote computing device over a network. In other examples, the device 340 can include a controller or other hardware to execute the instructions 346, 348 and/or perform the methods described herein.

In some examples the device 340 can include a processor 342 (e.g., processor resource, processing resource, etc.) communicatively coupled to a memory resource 344. As described further herein, the memory resource 344 can include instructions 346, 348 that can be executed by the processor 342 to perform particular functions. In some examples, the device 340 is coupled to a display device to display a user interface of a conferencing application.

The device 340 can include components such as a processor 342. As used herein, the processor 342 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 346, 348. In other examples, the device 340 can include instructions 346, 348 stored on a machine-readable medium (e.g., memory resource 344, non-transitory computer-readable medium, etc.) and executable by a processor 342. In a specific example, the device 340 utilizes a non-transitory computer-readable medium storing instructions 346, 348 that, when executed, cause the processor 342 to perform corresponding functions.

In some examples, the device 340 can include instructions 346 that can be executed by a processor 342 to designate a first portion of a user interface to share content with a remote device through a conferencing application. As described herein, the first portion of the user interface can be a sharing portion that can be a designated area of the user interface to be utilized for sharing content with the conferencing application. In this way, content that is within the first portion of the user interface can be provided to the conferencing application while content that is not within the first portion is not provided to the conferencing application.

In some examples, the device 340 can include instructions 348 that can be executed by a processor 342 to designate a second portion of the user interface to display the content from the conferencing application to represent the content as it is received by the remote device. As described herein, the second portion of the user interface can be a designated area to present the content provided to the conferencing application within the first portion. In this way, the second portion can represent the content as it is provided or as it is received by remote computing devices utilizing the conferencing application.

In some examples, the second portion of the user interface is restricted from being provided to the conferencing application. As described herein, the second portion of the user interface is not provided to the conferencing application. In some examples, the second portion of the user interface can overlap or be positioned within the first portion of the user interface. In these examples, overlapping the second portion on the first portion can include displaying the second portion over a portion of the first portion. In this way, the user interface may not display the portion that is overlapped by the second portion. However, the second portion may be designated to prevent the second portion from being provided to the conferencing application or is not displayed by a plurality of computing devices connected to the conferencing application. In this way, the second portion is not displayed by the plurality of computing devices and the portion that was overlapped by the second portion is displayed by the plurality of computing devices as if the second portion was not displayed by the user interface.

In these examples, the second portion can be designated as an exclude from capture region. As used herein, an exclude from capture region can prevent the corresponding region or area from being printed, captured in a screen shot, and/or prevented from being provided to an application. In this way, the second portion of the user interface can be positioned within the first portion and/or positioned over the images displayed within the first portion without transmitting the image data received from the conferencing application back to the conferencing application.

In some examples, the device 340 can include instructions to display network connection values between the conferencing application and the device. In these examples, the device 340 can include instructions to generate a notification when the network connection values are below a threshold network connection value. As described herein, the network connection values can be a signal strength for a network of the device 340 displaying the user interface. In these examples, a network connection value that is below the threshold network connection may not provide the image data or content within the first portion to the conferencing application. For example, the content within the first portion may not be provided to the conferencing application with the same or similar image quality. In this example, the image quality received by the remote computing devices may be below an image quality threshold when the network connection values are below the threshold network connection value.

In some examples, the device 340 can include instructions to designate a third portion of the user interface to display the notification when the remote device has displayed the content within the first portion of the user interface. As described herein, a designated portion of the user interface can be utilized to provide notifications to the user in response to determining when the content within the first portion is provided or displayed by the remote computing devices utilizing the conferencing application. In this way, a user utilizing the device 340 can be notified by a notification when a user of a remote computing device can see the content being shared within the first portion. In addition, the user utilizing the device 340 can be notified by a notification when the user of the remote computing device can not see the content being shared within the first portion.

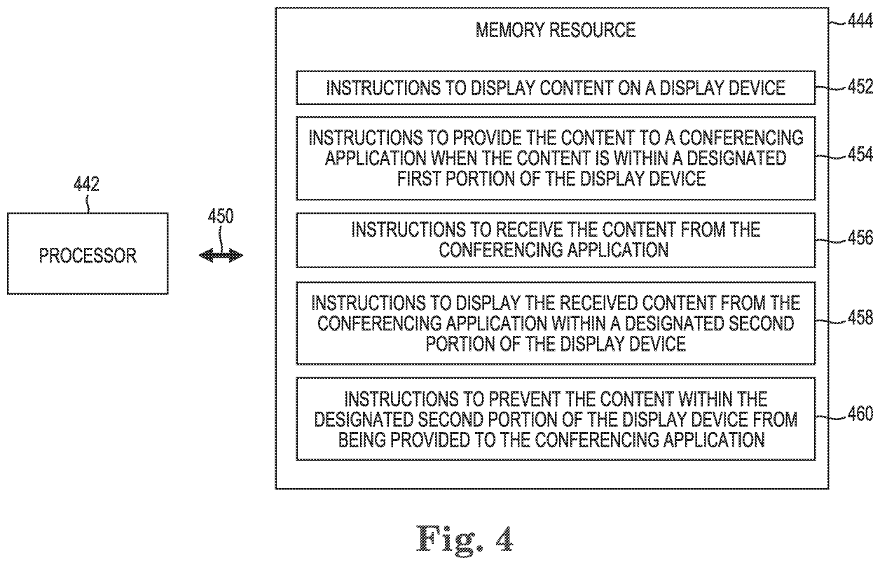

FIG. 4 illustrates an example of a memory resource 444 storing instructions 454, 456, 458, 460 for content sharing user interfaces. In some examples, the memory resource 444 can be a part of a computing device, computing system, or controller that can be communicatively coupled to a system that includes computing devices. For example, the memory resource 444 can be part of a device 340 as referenced in FIG. 3.

In some examples, the memory resource 444 can be communicatively coupled to a processor 442 that can execute instructions 454, 456, 458, 460 stored on the memory resource 444. For example, the memory resource 444 can be communicatively coupled to the processor 442 through a communication path 450. In some examples, a communication path 450 can include a wired or wireless connection that can allow communication between devices and/or components within a single device.

The memory resource 444 may be electronic, magnetic, optical, or other physical storage device that stores executable instructions. Thus, a non-transitory machine readable medium (MRM) (e.g., a memory resource 444) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 444) may be disposed within a controller and/or computing device. In this example, the executable instructions 454, 456, 458, 460, can be “installed” on the device. Additionally, and/or alternatively, the non-transitory machine readable medium (e.g., a memory resource 444) can be a portable, external or remote storage medium, for example, which allows a computing system or printing system to download the instructions 454, 456, 458, 460, from the portable/external/remote storage medium. In this situation, the executable instructions may be part of an “installation package”. As described herein, the non-transitory machine readable medium (e.g., a memory resource 444) can be encoded with executable instructions for content sharing user interfaces.

The instructions 452, when executed by the processor 442, can include instructions to display content on a display device. As described herein, the content can be image data (e.g., text, video, images, etc.) that is displayed through a user interface on a display device (e.g., display, monitor, television, etc.). In some examples, the content on the display device can be shared with a plurality of remote computing devices utilizing a conferencing application. That is, the content can be shared through a screen sharing function of the conferencing application such that a remote display device can display the same content that is displayed on the display device.

The instructions 454, when executed by the processor 442, can include instructions to provide the content to a conferencing application when the content is within a designated first portion of the display device. As described herein, the content can be positioned within a designated area of the user interface and shared with the conferencing application to be provided to a plurality of remote computing devices utilizing the conferencing application. In some examples, the first portion of the display device can be an entire area of the display device. In this way, the entire user interface can be shared with the conference application. In these examples, a second portion can be designated as an exclude from capture portion such that the second portion is not provided to the conferencing application. In these examples, the image data of the user interface is provided as if the second portion is not displayed on the user interface.

The instructions 456, when executed by the processor 442, can include instructions to receive the content from the conferencing application. As described herein, the user interface can utilize a virtual user with the conferencing application such that the conferencing application provides the content back to the device sending the content. In this way, the user interface can display the content of the virtual user to allow a user to view the shared content and the content as it is received by the plurality of remote devices utilizing the conferencing application.

The instructions 458, when executed by the processor 442, can include instructions to display the received content from the conferencing application within a designated second portion of the display device. As described herein, the user interface can include a designated second portion to display the received content to display what is received by the virtual user and/or the plurality of remote devices utilizing the conferencing application. As described herein, the second portion can be positioned over the image data displayed within the first portion of the user interface. In these examples, the second portion can be designated to not be provided to the conferencing application.

The instructions 460, when executed by the processor 442, can include instructions to prevent the content within the designated second portion of the display device from being provided to the conferencing application. As described herein, the second portion of the user interface displayed on the display device can be designated as a do not display or other designation such that it is not displayed by the plurality of devices utilizing the conferencing application. In this way, the second portion can be visible to the user of the user interface and appear invisible to the users of the plurality of remote devices utilizing the conferencing application.

In some examples, the memory resource 444 can include instructions to generate a notification to be displayed on the display device when the content within the designated second portion of the display is different than the content within the designated first portion for a threshold time period. In some examples, the content within the first portion can be compared to the content within the second portion to determine when there are differences that exceed a threshold difference. In this way, a lag or delay between the content within the first portion and the content received by the plurality of remote devices utilizing the conferencing application. In other examples, the differences can be utilized to determine that the content within the first portion is not being provided to the plurality of devices utilizing the conferencing application.

In other examples, the differences between the content within the first portion and the second portion can be utilized to determine when there is image quality issues with content displayed by the plurality of remote devices utilizing the conferencing application. For example, a video can be playing within the first portion and may not be playing above a quality threshold within the second portion. These differences can be utilized to determine when the quality of the content within the second portion is below a threshold quality.

In other examples, the memory resource 444 can include instructions to generate a notification when image quality metrics of the content within the designated second portion are below threshold quality metrics. In some examples, the image quality within the second portion can be analyzed individually to determine when the quality of the content within the second portion is below a threshold image quality. For example, image quality metrics (e.g., image quality assessment (IQA), etc.) can be determined for the content within the second portion to determine when the image quality is below a threshold.

In some examples, the memory resource 444 can include instructions to determine a type of content within the designated first portion and determine network connection value thresholds based on the type of content within the designated first portion. As described herein, the first portion can be utilized to share a plurality of different types of content (e.g., images, video, text, etc.). The type of content can utilize different quantities of computing resources (e.g., network bandwidth, processing resources, memory resources, etc.) to transfer to the plurality of remote devices utilizing the conferencing application. In this way, the network connection value threshold can be altered based on the type of content to ensure that content that utilizes a greater quantity of computing resources are assigned a relatively higher threshold value while content that utilizes a relatively lower quantity of computing resources are assigned a relatively lower threshold value.

In some examples, the memory resource 444 can include instructions to activate a virtual user for the conferencing application. In these examples, the virtual user provides the content to be displayed within the designated second portion. As described herein, the content displayed within the second portion can be provided by a virtual user of the conferencing application to mimic or mirror the content that is provided to the plurality of remote devices utilizing the conferencing application.

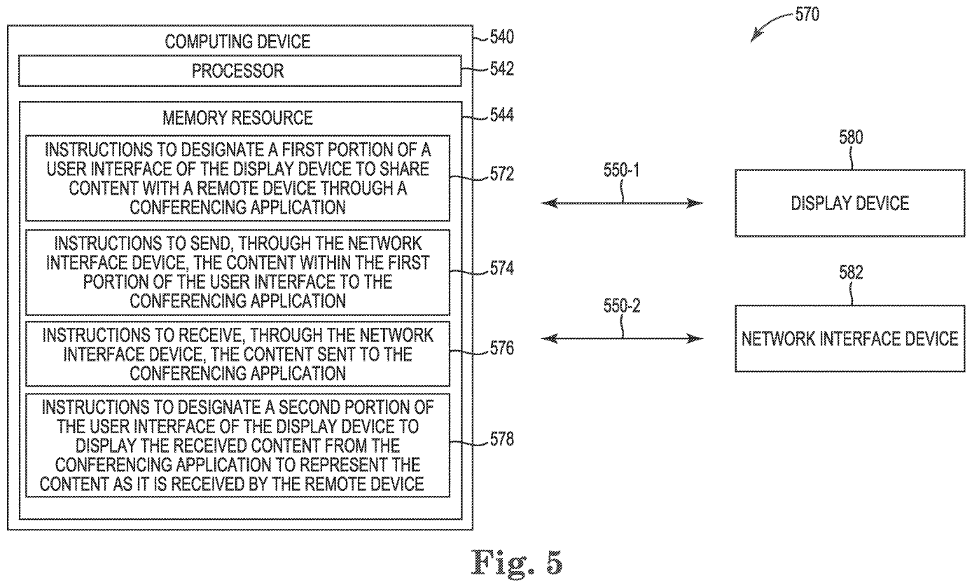

FIG. 5 illustrates an example of a system 570 for content sharing user interfaces. The system 570 can include a computing device 540 that is communicatively coupled to a display device 580 by a first communication path 550-1. In some examples, the computing device 540 can be communicatively coupled to a network interface device 582 by a second communication path 550-2. In some examples, the display device 580 can be utilized to display a user interface for the computing device 540.

In some examples, the network interface device 582 can be utilized to transmit and receive data from a plurality of remote computing devices through a network connection. In this way, a conferencing application associated with the computing device 540 can provide a conference session between the computing device 540 and the plurality of remote computing devices.

In some examples, the computing device 540 can include instructions 572 that can be executed by a processor 542 to designate a first portion of a user interface of the display device 580 to share content with a remote device through a conferencing application. As described herein, the conferencing application can be instructions to transmit and receive data to provide a conferencing session between a plurality of computing devices. In some examples, the first portion of the user interface can be a sharing portion that is designated to provide content within the boundary of the first portion.

In some examples, the computing device 540 can include instructions 574 that can be executed by a processor 542 to send, through the network interface device 582, the content within the first portion of the user interface to the conferencing application. The data within the first portion can be provided to the conferencing application to be provided to the plurality of remote computing devices utilizing the conferencing application.

In some examples, the computing device 540 can include instructions 576 that can be executed by a processor 546 to receive, through the network interface device 584, the content sent to the conferencing application. As described herein, the computing device 540 can receive the same content provided to the conferencing application as a virtual remote user. In this way, the content provided to the computing device 540 can represent the content received at the plurality of remote computing devices utilizing the conferencing application.

In some examples, the computing device 540 can include instructions 578 that can be executed by a processor 548 to designate a second portion of the user interface of the display device 580 to display the received content from the conferencing application to represent the content as it is received by the remote device. In these examples, the second portion of the user interface is restricted from being provided to the conferencing application.

In some examples, the computing device 540 includes instructions to display, on the display device 580, network connection values associated with the network interface device that represent a connection between the conferencing application and the network interface device 582. In these examples, the computing device 540 can include instructions to generate a notification when the network connection values are below a threshold network connection value. In these examples, the computing device 540 can include instructions to designate a third portion of the user interface to display a notification when the remote device has displayed the content within the first portion of the user interface.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The Figs herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 342 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A device, comprising:
a processor resource; and
a non-transitory memory resource storing machine-readable instructions stored thereon that, when executed, cause the processor resource to:
designate a first portion of a user interface to share content with a remote device through a conferencing application; and
designate a second portion of the user interface to display the content from the conferencing application to represent the content as it is received by the remote device.

2. The device of claim 1, wherein the processor resource is to display network connection values between the conferencing application and the device.

3. The device of claim 2, wherein the processor is to generate a notification when the network connection values are below a threshold network connection value

4. The device of claim 1, wherein the second portion of the user interface is restricted from being provided to the conferencing application.

5. The device of claim 1, wherein the processor is to designate a third portion of the user interface to display a notification when the remote device has displayed the content within the first portion of the user interface.

6. A system comprising:
a network interface device;
a display device;
a processor to:
designate a first portion of a user interface of the display device to share content with a remote device through a conferencing application;
send, through the network interface device, the content within the first portion of the user interface to the conferencing application;
receive, through the network interface device, the content sent to the conferencing application; and
designate a second portion of the user interface of the display device to display the received content from the conferencing application to represent the content as it is received by the remote device.

7. The system of claim 6, wherein the processor is to display, on the display device, network connection values associated with the network interface device that represent a connection between the conferencing application and the network interface device.

8. The system of claim 7, wherein the processor is to generate a notification when the network connection values are below a threshold network connection value.

9. The system of claim 6, wherein the second portion of the user interface is restricted from being provided.

10. The system of claim 6, wherein the processor is to designate a third portion of the user interface to display a notification when the remote device has displayed the content within the first portion of the user interface.

11. A machine-readable medium, storing machine-readable instructions which, when executed by a processor resource of a device, cause the processor to:
display content on a display device;
provide the content to a conferencing application when the content is within a designated first portion of the display device;
receive the content from the conferencing application;
display the received content from the conferencing application within a designated second portion of the display device; and
prevent the content within the designated second portion of the display device from being provided to the conferencing application.

12. The machine-readable medium of claim 11, comprising instructions to generate a notification to be displayed on the display device when the content within the designated second portion of the display is different than the content within the designated first portion for a threshold time period.

13. The machine-readable medium of claim 11, comprising instructions to generate a notification when image quality metrics of the content within the designated second portion are below threshold quality metrics.

14. The machine-readable medium of claim 11, comprising instructions to:
determine a type of content within the designated first portion; and
determine network connection value thresholds based on the type of content within the designated first portion.

15. The machine-readable medium of claim 11, comprising instructions to activate a virtual user for the conferencing application, wherein the virtual user provides the content to be displayed within the designated second portion.
